(19) United States
(12) Patent Application Publication
(10) Pub. No.: US 2019/0164055 A1
(43) Pub. Date: May 30, 2019

(54) TRAINING NEURAL NETWORKS TO DETECT SIMILAR THREE-DIMENSIONAL OBJECTS USING FUZZY IDENTIFICATION

(71) Applicant: Microsoft Technology Licensing, LLC, Redmond, WA (US)

(72) Inventors: Fredrik Carl Anders LJUNG LARHED, Linkoping (SE); Hans-Ulrik Tord LINDAHL, Linkoping (SE)

(21) Appl. No.: 15/826,664

(22) Filed: Nov. 29, 2017

(51) Int. Cl. G06N 3/08; G06N 3/04; G06K 9/62

(52) U.S. Cl. CPC G06N 3/084; G06K 9/6264; G06N 3/04

(57) ABSTRACT

A system for training a neural network generates a plurality of training meshes based on an input mesh. The plurality of training meshes include at least one mesh perceptually similar to the input mesh and one arbitrarily selected mesh perceptually dissimilar to the input mesh. The neural network is trained using the input mesh and the plurality of training meshes by tuning output of the neural network to identify similar non-identical meshes. The trained neural network is robust in identifying meshes similar to an unknown mesh input to the trained neural network.

### BACKGROUND

Neural networks are increasingly used in many application domains for tasks such as computer vision, robotics, speech recognition, medical image processing, computer games, augmented reality, virtual reality and others. For example, neural networks are increasingly used for classification and regression tasks for object recognition, lip reading, speech recognition, detecting anomalous transactions, text prediction, and many others. Typically, the quality of performance of the neural network depends on how well the network has been trained and the amount of training data available.

A neural network is a collection of layers of nodes interconnected by edges and where weights which are learned during a training phase are associated with the nodes. Input features are applied to one or more input nodes of the network and propagate through the network in a manner influenced by the weights (the output of a node is related to the weighted sum of the inputs). As a result, activations at one or more output nodes of the network are obtained.

The training process for neural networks generally involves using a training algorithm to update parameters of the neural network in an iterative process. Once trained, the neural networks may be used, for example, for image processing in the various application domains. In image processing systems, three-dimensional (3D) objects or scene surfaces are represented using polygon mesh models from which the image processing systems render images and video. However, neural networks are typically trained to only detect identical mesh matches. Accordingly, it is difficult or impossible for these neural networks to identify similar meshes (i.e., only exact matches can be identified). As a result, these trained neural networks may work unsatisfactorily for certain application domains or may require a user to manually search for similar meshes, which can be very tedious and time consuming.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for training a neural network comprises generating a plurality of training meshes based on an input mesh, wherein the plurality of training meshes include at least one mesh perceptually similar to the input mesh and one arbitrarily selected mesh perceptually dissimilar to the input mesh. The computerized method further comprises training the neural network using the input mesh and the plurality of training meshes by tuning output of the neural network to identify similar non-identical meshes. The computerized method also comprises using the trained neural network to identify meshes similar to an unknown mesh input to the trained neural network.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating an image processing system according to an embodiment;

FIG. 2 is an exemplary schematic block diagram of a neural network training system according to an embodiment;

FIG. 3 illustrates similar and dissimilar meshes according to an embodiment;

FIG. 4 is an exemplary block diagram illustrating feature computation according to an embodiment;

FIG. 5 illustrates normalization of an input according to an embodiment;

FIG. 6 illustrates inputs and outputs to a neural network according to an embodiment;

FIG. 7 is a table illustrating properties having input values according to an embodiment;

FIG. 8 illustrates a training process according to an embodiment;

FIG. 9 is an exemplary schematic block diagram illustrating a search process according to an embodiment;

FIGS. 10A and 10B are exemplary flow charts illustrating operations of a computing device for neural network training according to various embodiments; and

FIG. 11 illustrates a computing apparatus according to an embodiment as a functional block diagram.

Corresponding reference characters indicate corresponding parts throughout the drawings. In the figures, the systems are illustrated as schematic drawings. The drawings may not be to scale.

### DETAILED DESCRIPTION

The computing devices and methods described herein are configured to identify similar meshes using a neural network trained with a fuzzy hashing algorithm. Input properties for the neural network are computed for an original mesh (also referred to as an input mesh), but are also computed for some variations in the original mesh, which results in a more robust neural network. With the neural network trained according to the present disclosure, when given M number of values describing the properties of a 3D object, the trained neural network outputs N number of values that will be similar to the N output values for other perceptually similar 3D objects. Thus, in some examples, the neural network is trained to output similar features for similar meshes and not only exact matches.

The neural network is trained to output relevant distinguishing features by using “slightly” modified input geometry meshes. As used herein and described in some examples, “slightly” modified means that the modification to the mesh is still perceived by an observer to be similar to the original mesh (i.e., perceptually similar). With the present disclosure, machine learning is used to find an n-dimensional identifier of a 3D object that captures particular features relevant to distinguish that object from other 3D objects. Objects that are similar generate similar feature values, such that identifiers are invariant of scale, position and orientation, among other properties. Given a new (unknown or previously unused mesh) 3D object, the computing devices and methods described herein compute the object's n-dimensional identifier and use logistic regression to find the most similar 3D object(s) in a database. Thus, machine learning is used to identify whether two 3D objects are similar even if the two objects differ only slightly.

The neural network trained by the present disclosure is able to identify meshes similar to a new (unknown) mesh using fuzzy identification as a result of the tuning of the neural network during training. Thus, the trained neural network is able to more quickly and efficiently identify similar meshes, unlike neural networks that can only identify identical mesh matches. The searching to identify similar meshes is also more easily performed without the need for significant user input to search through mesh databases. As a result, processing time and processing resources needed for the searching are reduced.

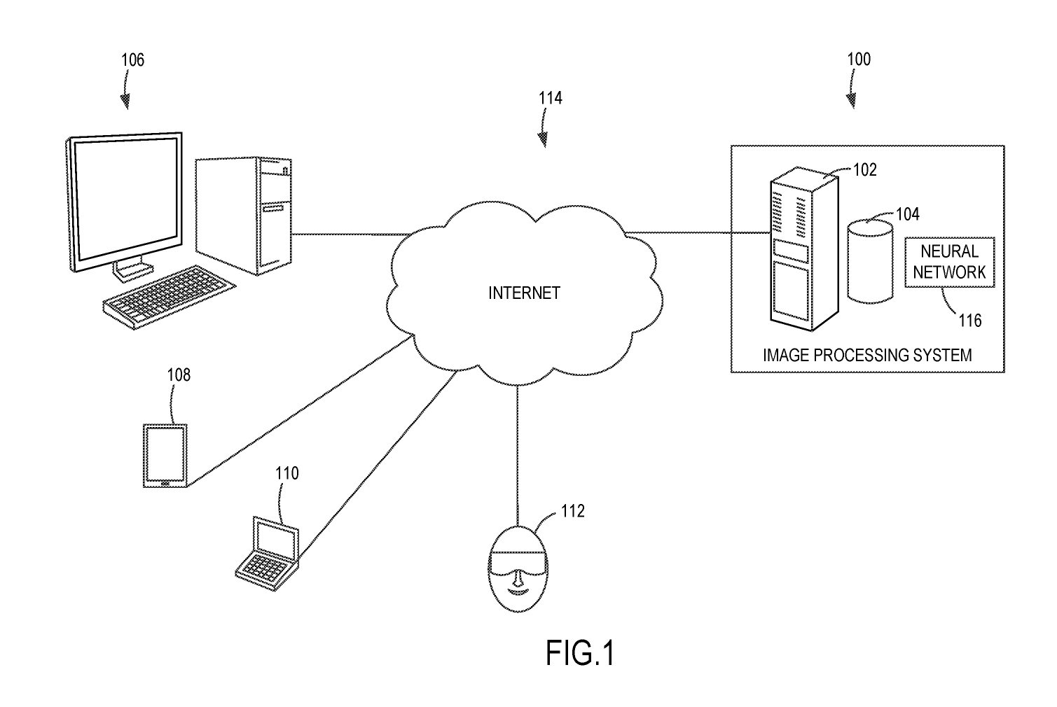

FIG. 1 is a schematic block diagram of an image processing system 100 deployed as a cloud service in this example. The image processing system 100 includes one or more computers 102 and storage 104 to store meshes (e.g., polygon meshes) and images/videos in some examples. The image processing system 100 is connected to one or more end user computing devices, such as a desktop computer 106, a smart phone 108, a laptop computer 110 and an augmented reality head worn computer 112 (e.g., Microsoft HoloLens®). For example, the image processing system 100 is shown as connected to the end user computing devices via a computer network 114, illustrated as the Internet.

The image processing system 100 receives images (e.g., 3D images or models) from an end user computing device, such as in the form of models created using 3D modeling or computer aided design software or 3D scene reconstructions from an augmented reality system or depth camera system. For example, a content creator such as a 3D artist or a robotic system that creates scanned 3D models of environments, forms 3D images and models using suitable computing devices. The images and/or models are then uploaded to the processing system 100. It should be appreciated that some or all of the image processing system 100 or the functionality of the image processing system 100 can be implemented within the end user computing device.

The image processing system 100 uses a neural network 116 trained according to the present disclosure to output similar features for similar (non-identical) objects (e.g., meshes). In one example, the image processing system 100 use the neural network 116 trained to identify an array of “self-taught” important features for a 3D object (formed from image voxels). If two 3D objects generate features with similar values, then the objects are deemed to be similar by the image processing system 100. Given a large training set of 3D objects, one example trains the neural network 116 by inputting Mesh A, Mesh A′ (Mesh A slightly modified, but perceptually similar), and Mesh B (arbitrary mesh dissimilar from Mesh A). The neural network 116 is trained to determine what makes Mesh A and Mesh A′ similar and different from Mesh B.

When the neural network 116 is trained, a large amount of 3D objects can be processed and the n-dimensional identifier of the objects can be stored in a database, such as in the storage 104. In operation, given a new 3D object, the image processing system 100 is configured to compute the n-dimensional identifier and use logistic regression to find the most similar 3D object(s) in the database. In one example, the image processing system 100 uses machine learning with the neural network 116 to find an n-dimensional identifier of a 3D object that captures particular features relevant to distinguish the object from other 3D objects using identifiers that are invariant of scale, position and orientation. Thus, using the neural network 116, the image processing system 100 is operable to perform image analysis using a fuzzy hashing algorithm instead of an exact hashing algorithm. The end user computing devices 106, 108, 110, 112 are able to load one or more matching meshes (e.g., polygon meshes) identified using the fuzzy hashing algorithm.

In some examples, the functionality of the image processing system 100 described herein is performed, at least in part, by one or more hardware logic components. For example, and without limitation, illustrative types of hardware logic components that are used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

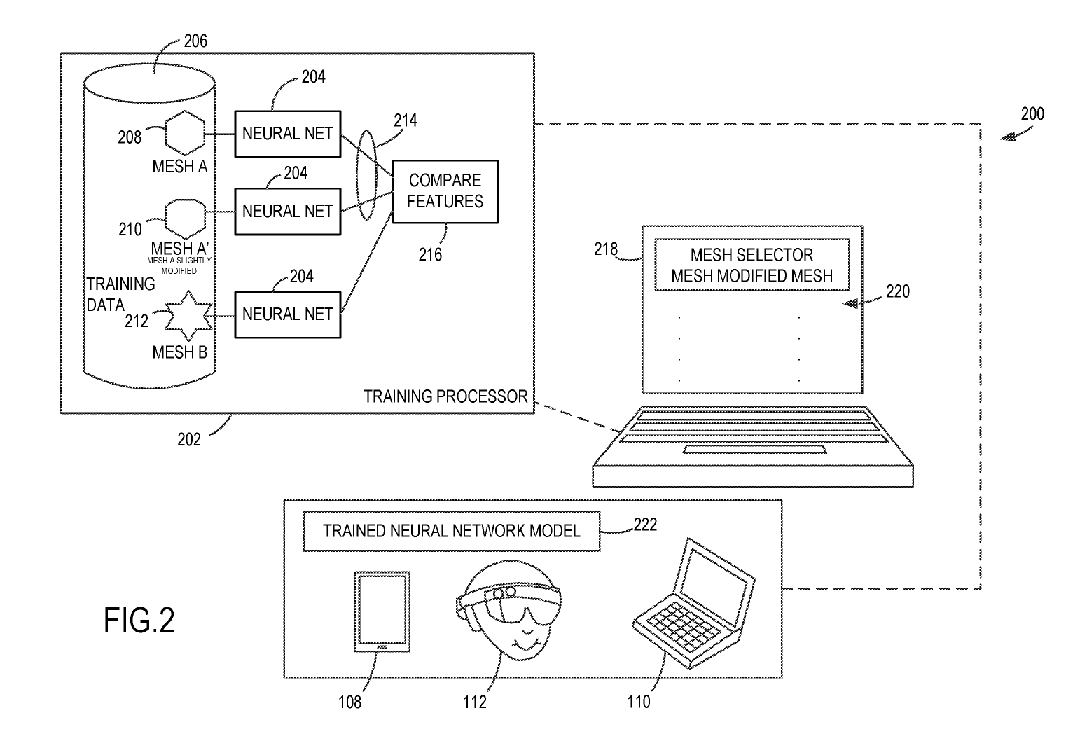

Various examples include a neural network training system 200 as illustrated in FIG. 2. The neural network training system 200 in one example uses back propagation or other training techniques. The neural network training system 200 includes a training processor 202 that uses machine learning to find an n-dimensional identifier of a 3D object (e.g., 3D mesh) that captures particular features relevant to distinguish the 3D object from other 3D objects, such that a neural network 204 is trained to generate similar feature values for similar objects (that are not identical).

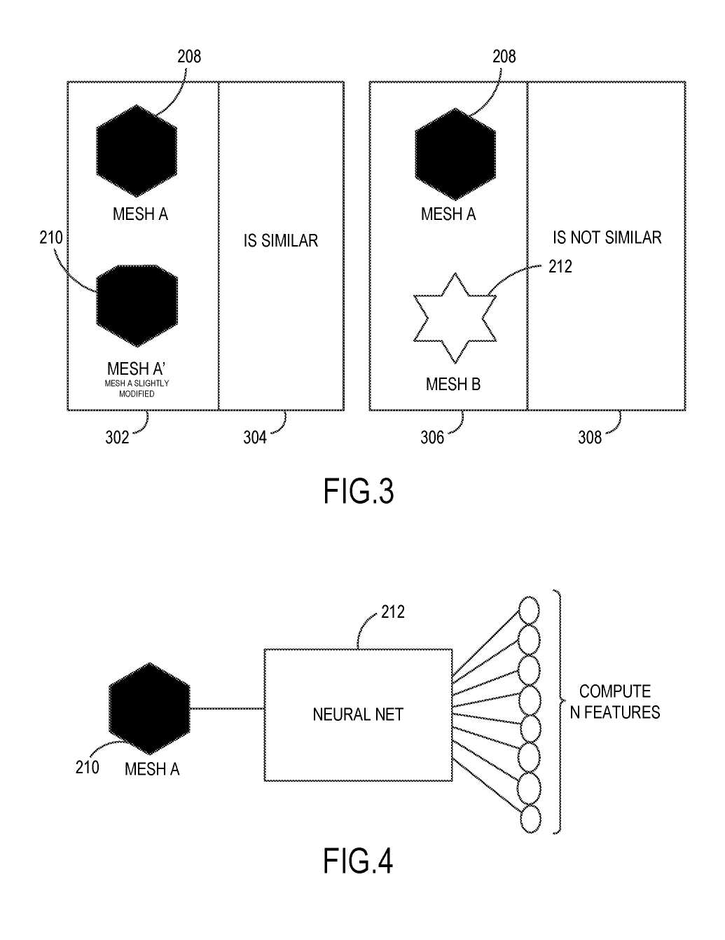

The training processor 202 has access to training data 206 for training the neural network 204. In one example, the neural network 204 is trained using a set of three meshes, illustrated as an original mesh 208 (Mesh A) being an input mesh, a first training mesh 210 (mesh A′) and a second training mesh 212 (Mesh B). The training processor uses the meshes 208, 210, 212 to train the neural network 204 such that the same or similar output 214 is generated when the input is the original mesh 208 or the first mesh 210. For example, as illustrated in FIG. 3, the inputs 302, which include the mesh 208 or the mesh 210, generate a similar output 304 even though the mesh 208 and the mesh 210 are not identical. The inputs 306, which include the mesh 208 or the mesh 212, generate an output 308 that is not similar. Thus, non-identical, but similar meshes can be identified by the neural network 204 trained according to the present disclosure.

It should be noted that the meshes 208, 210 and 212 are illustrated as two-dimensional (2D) objects merely for ease of illustration and various examples are implemented in connection with 3D objects, such as defined by 3D meshes. Also, the original mesh in various examples refers to a base mesh or input mesh that is modified. It should also be noted that the first training mesh 210 (mesh A′) in some examples is computed generated and in some examples created by a person using a 3D modeling tool. A user imports the original mesh 208 (Mesh A) and the neural network 204 is trained with the model that the user exports (i.e., the first training mesh 210 (mesh A′)) after having modified the original imported mesh.

Referring again to FIG. 2, in one example, given a large training set of 3D objects, the training processor 202 trains the neural network 204 by inputting a base Mesh A, illustrated as the original mesh 208, a slightly modified Mesh A′, illustrated as the first training mesh 210, and a completely different Mesh B (e.g., an arbitrary mesh that is not perceptually similar to the original mesh 208), illustrated as the second training mesh 212. The training processor 202 is configured to train the neural network 204 to determine what properties (based on corresponding input values) of the original and first training meshes 208 and 210 make these meshes similar and what properties (based on corresponding input values) of the original and second training meshes 208 and 212 make these meshes different. For example, the neural network 204, computes from the original mesh 208, n features for the original mesh 208, which are relevant distinguishing features for use in determining the similarity between meshes. The features may be based on a defined set of properties. Using the computed features for each of the meshes, such as the meshes 208 and 210, the training process including comparing the computed features at 216, such as during an iterative back propagation process, wherein the neural network 204 is trained to output similar features for similar meshes.

In one example, backward propagation (also referred to as a backward propagation of errors) is used to train the neural network 204 in combination with an optimization method, such as gradient descent. In some examples, the process includes a two-phase cycle (or propagation and a weight update). For example, a back-propagation algorithm comprises inputting a labeled training data instance to the neural network 204, propagating the training instance through the neural network 204 (referred to as forward propagation or a forward pass) and observing the output. The training data instance is labeled and so the ground truth output of the neural network 204 is known and the difference or error between the observed output and the ground truth output is found and provides information about a loss function, which is passed back through the neural network layers in a backward propagation or backwards pass. A search is made to try find a minimum of the loss function, which is a set of weights of the neural network 204 that enable the output of the neural network 204 to match the ground truth data. Searching the loss function is achieved using gradient descent or stochastic gradient descent or in other ways, and as part of this process gradients are computed. The gradient data is used to update weights of the neural network 204.

In one example, the training processor 202 has details of the neural network 204 topology (such as the number of layers, the types of layers, how the layers are connected, the number of nodes in each layer, the type of neural network), which are specified by an operator. For example, an operator is able to specify the neural network topology using a graphical user interface 218. When the neural network 204 is trained, a large amount of 3D objects can be processed and corresponding n-dimensional identifiers can be stored in a database. For example, the database can include n-dimensional identifiers corresponding to thousands of 3D objects.

In some examples, the operator is able to select a tuning parameter of the neural network training system 200 using a mesh selector interface 220 or other selection means. The tuning parameter controls the granularity of the compared features used in the training, such as based on the number of meshes to compare and/or the number of similarities and differences between the compared meshes. Once the operator has configured one or more tuning parameters, the training processor 202 is configured to perform neural network training computations to train the neural network 204 to output similar features for similar non-identical meshes (although identical meshes will also output similar features, more particularly, the same features). In some examples, one or more of the tuning parameters are automatically selected. For example, the second training mesh 212 may be arbitrarily selected as a random mesh dissimilar from the original mesh 208. As another example, the first training mesh 210 is generated based on one or more changes that are automatically made to one or more properties of the original mesh 208 (e.g., arbitrarily change the value of one or more properties).

In one example, once the training of the neural network 204 is complete (for example, after the training data is exhausted) a trained neural network 222 model (topology and parameter values) is stored and loaded to one or more end user devices such as the smart phone 108, the wearable augmented reality computing device 112, the laptop computer 110 or other end user computing device. The end user computing device is able to use the trained neural network 204 to carry out the task for which the neural network 204 has been trained. For example, in the case of the wearable augmented reality computing device 112, an engine is opened to recognize assets being looked at by the wearer of the wearable augmented reality computing device 112 and the trained neural network 204 is used to understand how the assets are oriented, whether the asset is opened, etc.

In various examples, the neural network 204 is configured for fuzzy identification of similar 3D objections. The neural network 204 is trained such that when given M number of values describing the properties of the 3D object, the neural network 204 outputs N number of values that will be similar to the N output values for other perceptually similar 3D objects. For example, threshold value differentials (variances) or numbers of differing properties are set to define whether 3D objects are perceptually similar or perceptually dissimilar.

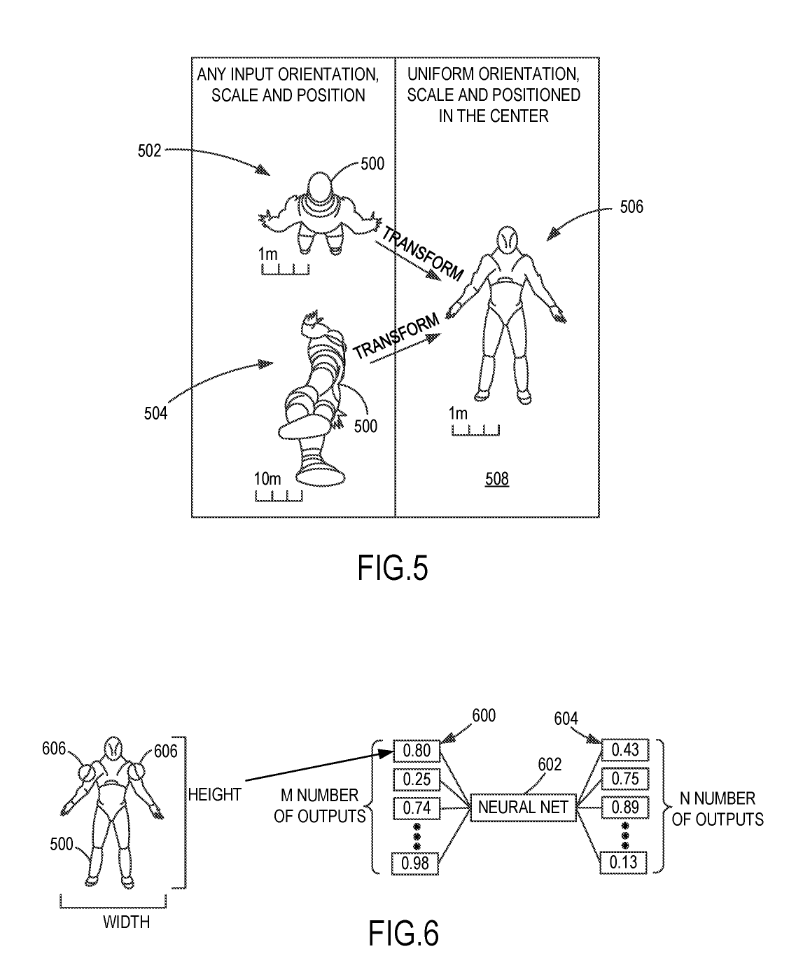

It should be noted that in various examples, before the properties of arbitrary objects are extracted for use in comparing the features of the objects defined by the properties, the objects are normalized. For example, as shown in FIG. 5, an object 500 may have a first orientation as shown at 502 or a second orientation as shown at 504. Additionally, the scale of the object 500 at 502 is different than the scale of the object 500 at 504 (illustrated as larger at 504). In one example, the orientation and size of the object 500 at 502 or the orientation and size of the object 500 at 504 are transformed and normalized to a uniform orientation and scale at 506.

The orientation and size can be normalized to any rotation or size with the object 500 generally positioned in a center of an evaluation area 508, thereby also normalizing position. The transforming can be performed using different transforming techniques, such as digital scaling or rotation. Additionally, other properties of the object 500 can be normalized, such as based on the complexity of the object 500. In the illustrated example, the object 500 at 502 and at 504 has the same mesh, but with different orientation, scale and position. In one example, the object at 502 and at 504 are transformed using a principal component analysis (PCA) to determine an orientation based on the mesh's geometry regardless of an initial orientation.

Information regarding the mesh is then extracted from the mesh in a normalized state, including a number of properties (the number can be varied) that are used to train the neural network 204 as described herein. For example, if one input is height and one input is width, the neural network 204 creates internal logic between the two inputs so that the neural network 204 outputs features that are similar if objects have similar height-width-ratios. As illustrated in FIG. 6, the properties (relating in this example to height and width) are extracted as values 600 (e.g., height of the mesh) that define inputs to a neural network 602. From these inputs, the neural network 602 generates corresponding output values 604 that represent some combination of any number of the input values 600. As should be appreciated, the values 600 relate to the particular features of the mesh of the object 500 that are compared when generating a similar mesh (e.g., the object 500 with certain features removed, such as the arm features 606), to train the neural network 204 to perform a fuzzy identification of objects that have similar meshes. It should be appreciated that different values for the 3D object (that has been normalized) are input to the neural network 602 in some examples. These values include, but are not limited to, values relating to volumetric information, shape information (e.g., length, height, depth, etc.), and topology information (triangle count, vertex count, connectivity, etc.), among others. The neural network 602 then outputs n features based on operations performed between the input values by the neural network 602.

As should be appreciated, different properties can be extracted. In one example, a defined list 700 of properties is used for training. The list 700 can include any number or properties 702, which then are extracted to determine a value 704 for each of these properties 702. In one example, all the properties are computed for the original mesh (e.g., the original mesh 208 shown in FIG. 2) and also computed for one or more variations of the original mesh (e.g., the first training mesh 210 shown in FIG. 2) to make the neural network 204 more robust. It should be appreciated that in some examples, less than all the properties are computed or used when training the neural network, such as based on a desired time for training or accuracy in the fuzzy identification.

In some examples, where a particular geometry mesh is incomplete, using the extracted properties from similar meshes, a repaired geometry is created by welding together (connecting) vertices and closing the gaps in the geometry. Thereafter, all the properties for the repaired geometry are computed. As another example, a proxy mesh is created, which is a replacement mesh where holes are filled and insides and other redundant geometry removed. Here again, all the properties for the replacement mesh can then be calculated.

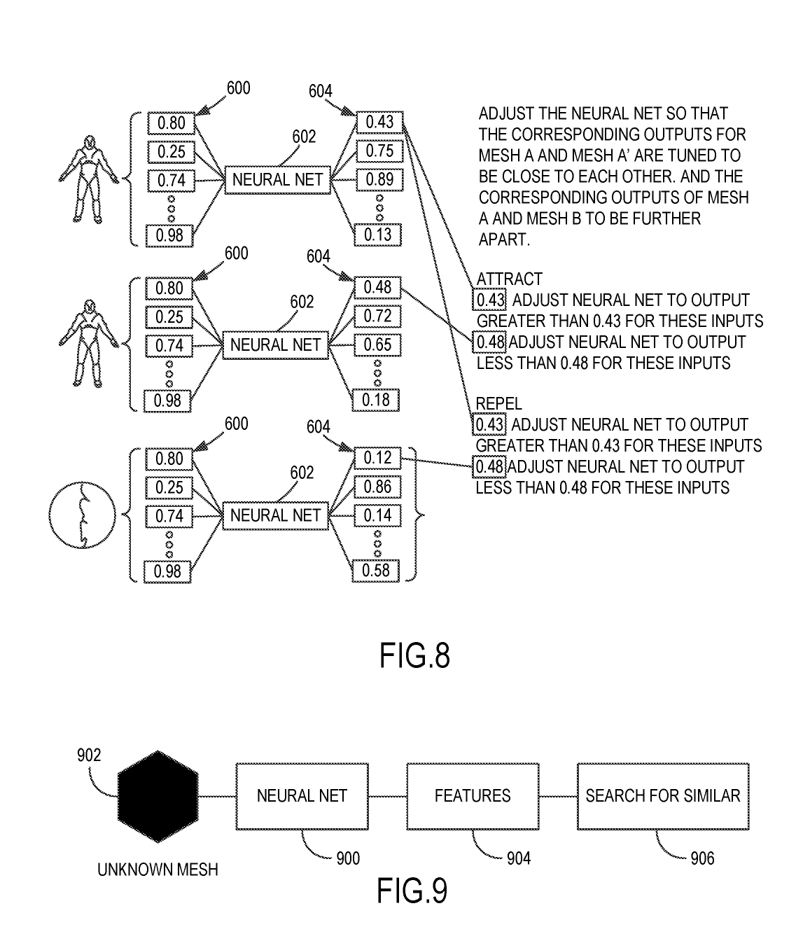

The training of neural networks according to the present disclosure includes making the outputs from the neural networks similar for similar meshes (e.g., perceptually similar meshes). This training process increases the likelihood that when an unknown mesh is the input, the neural networks identify similar meshes that otherwise would not be identified if exact mesh matches were required. For example, as illustrated in FIG. 8, a first mesh 800 and a second mesh 802 used for training are perceptually similar. In this example, the first and second meshes 800 and 802 define a figure with the second mesh 802 having a part 804 removed, illustrated as the portion of the mesh that defines a hand of the figure. The difference between the first and second meshes 800 and 802 may be automatically generated, such as by a random removal of the part 804 or may be manually generated by a user. Additionally, a third mesh 806 is used in the training process that is randomly generated or selected and defining an object dissimilar from the object defined by the first and second meshes 800 and 802, thereby defining a perceptually dissimilar mesh.

The meshes 800, 802 and 806 are input to a neural network 812, such as by extracting values 808 for relevant distinguishing features for each of the meshes 800, 802 and 806. As described herein, the meshes 800, 802 and 806 are normalized in some examples before the values 808 for the relevant distinguishing features are extracted. The neural network 812 processes the input values 808 and generates output values 810 for each of the meshes 800, 802 and 806. The training process in this example includes adjusting the neural network 812, such as by adjusting the calculating parameters for the neural network 812 so that the corresponding output values 810 for the first and second meshes 800 and 802 are tuned to be close to each other. That is, the neural network 812 is adjusted so that the output values 810 for the relevant features converge to the same value or a value within a defined threshold variance that allows for subsequent identification of the first and second meshes 800 and 802 as similar meshes, such as being perceptually similar meshes. Additionally, the neural network 812 is adjusted so that the output values 810 for the relevant features of the first mesh 800 and the third mesh 806 (which are not perceptually similar) diverge to be further apart, for example, to be outside of the defined threshold variance.

More particularly, in the illustrated example, an attraction adjustment is performed with respect to the outputs 810. For example, with respect to the outputs 810, the first value for the outputs corresponding to the meshes 800, 802 and 806 are 0.43, 0.48 and 0.12, which correspond to an extracted relevant feature of the meshes 800, 802 and 806. The neural network 812 is adjusted so that the 0.43 and 0.48 output values 810 are brought closer together (i.e., a smaller difference) by causing an increase in the 0.43 value (output) and a decrease in the 0.48 value (output) for this particular feature. For example, the adjusted values may be passed in the reverse direction (backward propagating) to the neural network 812 to converge outputs to the same or similar value. The neural network 812 is also adjusted so that the 0.43 and 0.12 output values 810 are made farther apart (i.e. a greater difference) by causing an increase in the 0.43 value (output) and a decrease in the 0.12 value (output) for this particular feature. For example, the adjusted values may be passed in the reverse direction (backward propagating) to the neural network 812 to diverge outputs to the dissimilar values. The adjustment is performed for one or all of the output values 810 such that the neural network 812 is trained such that the output values 810 for the first and second meshes 800 and 802 can be identified as being similar and the outputs values 810 for the first and third meshes 800 and 806 can be identified as being dissimilar.

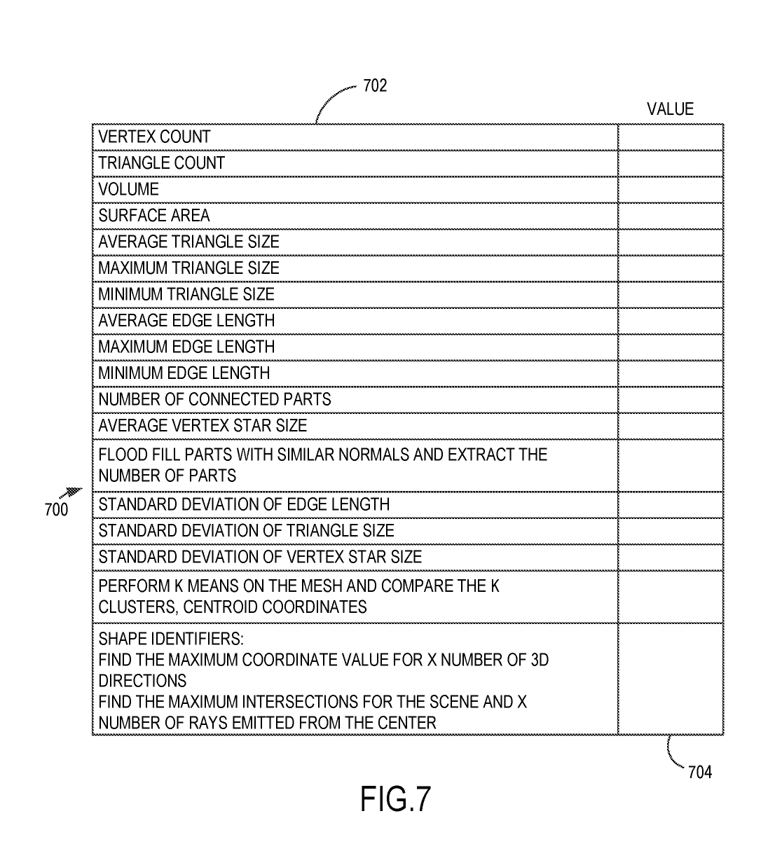

Thus, using properties computed for similar meshes, the neural network 204 is trained to output relevant distinguishing features with similar values for similar meshes to allow for easier identification of similar meshes by the neural network. That is, by slightly modifying the input geometry mesh and introducing a third random geometry, the neural network 204 is trained to output the relevant distinguishing features that allows for a fuzzy determination of similar meshes. The trained neural network 204 is then able to output similar features for similar meshes to identify these similar meshes, instead of requiring an exact match between the meshes to make the matching identification. For example, as illustrated in FIG. 9, with a neural network 900 trained in accordance with the present disclosure, an unknown mesh 902 (e.g., a mesh not exactly the same or identical to another mesh stored in a database) can be input and the relevant features 904 extracted. With the relevant features extracted 904, which can be the properties 702 (illustrated in FIG. 7), a search is performed for similar meshes. For example, perceptually similar objects have the same neural network outputs when the neural network 900 is trained as described herein. The search at 906 in one example includes identifying meshes having similar features defined by similar outputs, such as meshes having output values for the relevant properties within a predetermined variance of the values for the relevant features of the unknown mesh 902 input into the neural network 900. The trained neural network 900 can be used on the unknown mesh 902 to produce the set of features 904 used to search a database of pre-existing 3D object feature values to identify any similar meshes. Fuzzy and robust detection of mesh features is thereby provided. Thus, the trained neural network can take an arbitrary previously unused mesh (such as an unknown mesh) and compute a list of features for that mesh that are similar to the features of a perceptually similar already processed mesh.

Thus, the neural network 900 is trained to output “better” (more relevant) features by comparing the features produced by the same neural network for a plurality of training meshes as described herein. As should be appreciated, additional similar and dissimilar meshes corresponding to a base or original mesh may be used in the training process. For example, the training process is performed and repeated many times for a number of different 3D objects.

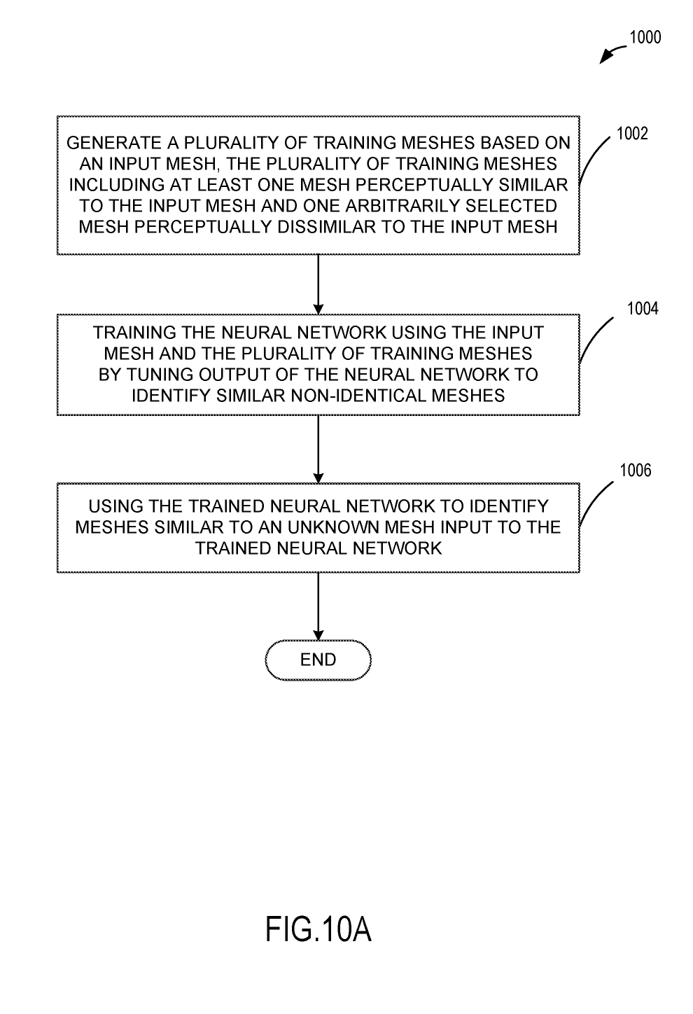

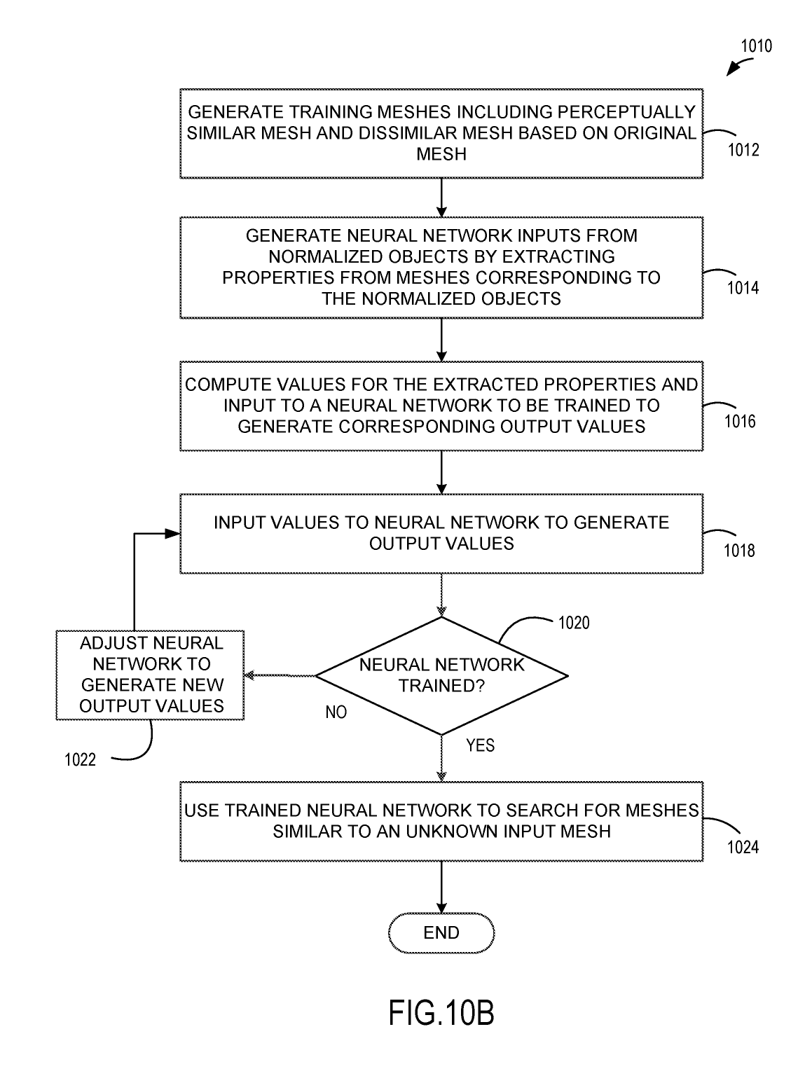

FIGS. 10A and 10B illustrate exemplary flow charts of methods 1000 and 1010 for training a neural network. In particular, these figures are exemplary flow charts illustrating operations of a computing device to train a neural network for use in searching for objects having similar meshes. The operations illustrated in the flow charts described herein may be performed in a different order than is shown, may include additional or fewer steps and may be modified as desired or needed. Additionally, one or more operations may be performed simultaneously, concurrently or sequentially.

With reference to the method 1000 illustrated in FIG. 10A, at 1002, the computing device generates a plurality of training meshes based on an input mesh, the plurality of training meshes including at least one mesh perceptually similar to the input mesh and one arbitrarily selected mesh perceptually dissimilar to the input mesh. For example, an input mesh having a mesh with defined properties is selected or generated. The input mesh is modified such that the new mesh looks similar to the input mesh, but is not identical to the input mesh (e.g., a property of feature added, removed or changed). This new mesh defines a mesh perceptually similar to the input mesh (e.g., perceptually visually similar). The mesh that is perceptually dissimilar may be arbitrarily selected or generated and has a plurality of features different than the input mesh (e.g., property of several features added, removed or changed, or being a totally different object mesh).

At 1004, the computing device trains the neural network using the input mesh and the plurality of training meshes by tuning output of the neural network to identify similar non-identical meshes. For example, one or more control parameters or nodes of the neural network are changed to indirectly change the output generated by the neural network. The neural network is adjusted in some examples to cause the outputs generated from the input mesh and the mesh perceptually similar to the input mesh to converge to same or similar values, and the outputs generated from the input mesh and the arbitrarily selected mesh perceptually dissimilar to the input mesh to diverge to different values.

At 1006, the computing device uses the trained neural network to identify meshes similar to an unknown mesh input to the trained neural network. For example, using fuzzy identification the neural network identifies non-identical meshes that are similar to a new mesh input to the neural network (e.g., meshes having similar properties and/or features).

With reference now to the method 1010 illustrated in FIG. 10B, at 1012, training meshes are generated for use in training the neural network. In some examples, an original or base mesh defines a first training mesh. The computing device generates additional training meshes based on the original or base mesh. For example, at least one similar mesh and at least one different mesh are also generated, which define at least second and third training meshes for the training process. The one or more similar meshes in some examples are generated by changing a feature of the first training mesh such that the first (original) and second meshes are not identical, but perceptually similar. As described herein, the first training mesh can be modified automatically or manually to change a feature in the appearance of the first training mesh to create the second training mesh. In some examples, the second training mesh is generated by transforming the first training mesh as might occur in a real-world environment (e.g., a computer-aided design (CAD) revision). The third training mesh is generated or selected as a mesh having features in appearance that are different than the first training mesh, such as a mesh defining a different object (e.g., a globe instead of a figure of a person).

While three training meshes are described, various examples use many more training meshes, which may number in the hundreds, as part of the training process and that define training data for use in training the neural network. Additionally, the training meshes in some examples correspond to 3D graphics images that have been tiled into a polygon mesh, such as triangles or other polygon shapes. For example, in one example, the training meshes are polygon meshes have a plurality of vertices linked by edges and where the edges form closed 2D polygons.

Neural network inputs are then generated by the computing device at 1014. In one example, neural network inputs are generated from normalized objects corresponding to the training meshes. The neural network inputs are generated by extracting properties from the training meshes corresponding to the normalized objects. For example, appearance features of the training meshes (e.g., height, width, etc.) are defined for each of the training meshes, which will be used as inputs to train the neural network. In some examples, the meshes are normalized such that meshes are oriented along a primary access and similarly scaled, which are then used to extract properties for each of the normalized training meshes.

The computing device computes values for the extracted properties at 1016 that are used as inputs to the neural network to be trained. For example, measurement values for each of the extracted values are electronically or digitally calculated. The values for the extracted values for each of the training meshes are then input to the neural network to be trained to generate corresponding output values at 1018. For example, the computing device runs the neural network on the input values, which are combined to generate corresponding output values for each of the training meshes. The output values represent a combination of the input values and define output features for each of the training meshes.

A determination is then made at 1020 whether the neural network is trained. For example, a determination is made as to whether the neural network has been tuned to a level such that the neural network outputs similar features for similar meshes (e.g., the output values for similar meshes are within a defined amount or variance). If the neural network has not been trained with respect to the training meshes, which may be multiple sets of different meshes, at 1022, the computing device further adjusts the neural network to generate new output values, such as to output similar values for meshes having similar properties (e.g., to converge the output values). Continuing with the example above that includes the three training meshes, an iterative training process is performed to fine tune the neural network outputs such that the outputs of the first and second training meshes are made to converge to the same or similar values and the outputs of the first and third training meshes are made to diverge to different values. For example, the output values corresponding to the extracted features for the first training mesh and the second training mesh are caused to have a smaller difference in value and the output values corresponding to the extracted features for the first training mesh and the third training mesh are caused to have a larger difference in value.

As should be appreciated, the training process for neural networks generally involves using a training algorithm such as backpropagation to update parameters of the neural network in an iterative process. In the method 1010, one examples uses the training algorithm to adjust the output values resulting in the trained neural network outputting similar features for similar meshes, such that the computing device can thereafter search for non-identical similar meshes for an unknown input mesh (e.g., a mesh having an appearance and properties that are not identical to any other meshes stored in the database).

As should also be appreciated, a neural network is a collection of nodes interconnected by edges and where there are weights associated with the nodes and/or edges. A linear or non-linear function can be applied in each node to produce an activation thereof. During the training phase by the method 1010, the weights are updated according to update rules in the light of training examples. Thus, in one example, the neural network is adjusted to cause the change in the output values by changing the weights used by the neural network. In some examples, one or more of the nodes in the neural network is modified to slightly change the way the neural network operates. Thus, the outputs themselves are not directly changed, but indirectly changed by changing how the nodes operate to generate the outputs.

In operation, in one example, the neural network having the modified nodes takes the inputs and combines the inputs with linear operations through the layers and outputs a value that is fine-tuned according to aspects of the present disclosure. It should be noted that any modification to the neural network that results in changes to the output values to converge or diverge the values is contemplated by this disclosure.

With the trained neural network (i.e., a determination is made at 1020 that the neural network is trained), the computing device is able to use the neural network to search for meshes similar to an unknown input mesh at 1024. For example, an input mesh in some examples is not identical to any other stored mesh. Without the present disclosure, the neural network is unable to identify a matching mesh and outputs a null set. With the trained neural network, similar non-identical meshes can be identified, which correspond to stored meshes having similar features. Thus, in some examples, the method 1000 tunes the neural network to make the outputs similar for the similar training meshes, so that the neural network always outputs the same values/features (or values within a defined variance) given these two meshes as inputs. As such, unknown meshes may be processed by the trained neural network to identify similar non-identical meshes using fuzzy processing.

Exemplary Operating Environment

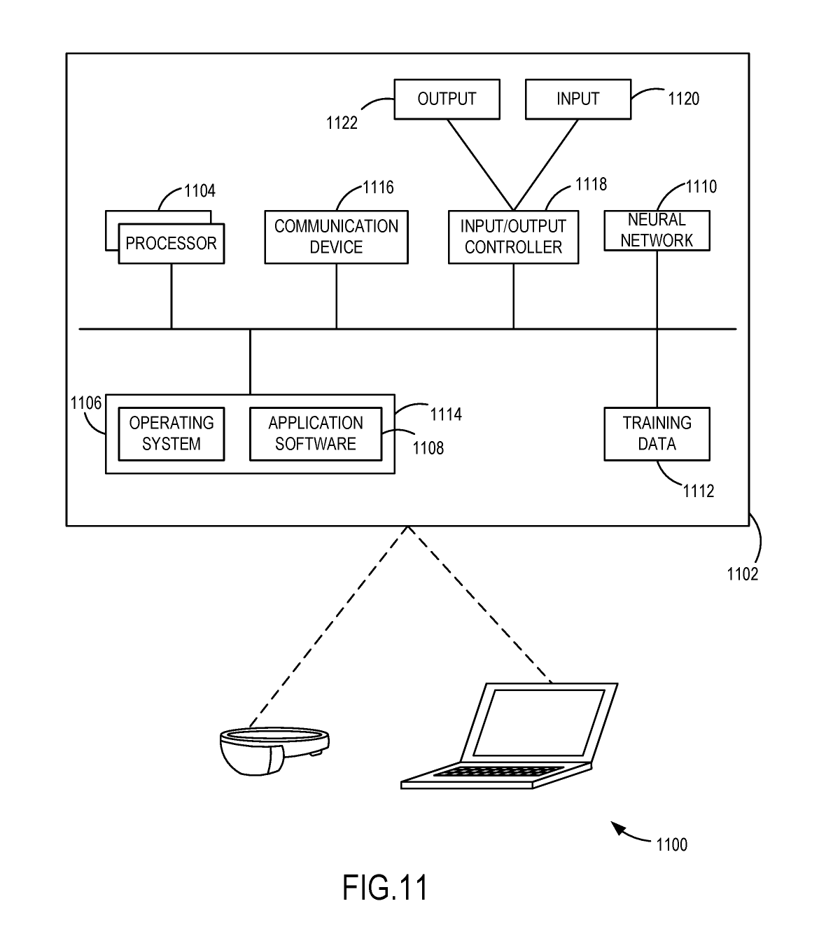

The present disclosure is operable with a computing apparatus 1102 according to an embodiment as a functional block diagram 1100 in FIG. 11. In one example, components of the computing apparatus 1102 may be implemented as a part of an electronic device according to one or more embodiments described in this specification. The computing apparatus 1102 comprises one or more processors 1104 which may be microprocessors, controllers or any other suitable type of processors for processing computer executable instructions to control the operation of the electronic device. Platform software comprising an operating system 1106 or any other suitable platform software may be provided on the apparatus 1102 to enable application software 1108 to be executed on the device. According to an embodiment, training of a neural network 1110 using training data 1112 and identifying similar 3D objects using a fuzzy detection algorithm of the trained neural network 1110 may be accomplished by software.

Computer executable instructions may be provided using any computer-readable media that are accessible by the computing apparatus 1102. Computer-readable media may include, for example, computer storage media such as a memory 1114 and communications media. Computer storage media, such as the memory 1114, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1114) is shown within the computing apparatus 1102, it will be appreciated by a person skilled in the art, that the storage may be distributed or located remotely and accessed via a network or other communication link (e.g. using a communication interface 1116).

The computing apparatus 1102 may comprise an input/output controller 1118 configured to output information to one or more input devices 1120 and output devices 1122, for example a display or a speaker, which may be separate from or integral to the electronic device. The input/output controller 1118 may also be configured to receive and process an input from the one or more input devices 1120, for example, a keyboard, a microphone or a touchpad. In one embodiment, the output device 1122 may also act as the input device 1120. An example of such a device may be a touch sensitive display. The input/output controller 1118 may also output data to devices other than the output device 1122, e.g. a locally connected printing device. In some embodiments, a user may provide input to the input device(s) 1120 and/or receive output from the output device(s) 1122.

In some examples, the computing apparatus 1102 detects voice input, user gestures or other user actions and provides a natural user interface (NUT). This user input may be used to author electronic ink, view content, select ink controls, play videos with electronic ink overlays and for other purposes. The input/output controller 1118 outputs data to devices other than a display device in some examples, e.g. a locally connected printing device.

NUI technology enables a user to interact with the computing apparatus 1102 in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

The functionality described herein can be performed, at least in part, by one or more hardware logic components. According to an embodiment, the computing apparatus 1102 is configured by the program code when executed by the processor(s) 1104 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:

A system for training a neural network, the system comprising:

at least one processor; and

at least one memory comprising computer program code, the at least one memory and the computer program code configured to, with the at least one processor, cause the at least one processor to:

generate a plurality of training meshes based on an input mesh, at least one of the training meshes being a mesh having similar properties to the input mesh, wherein at least one property of the mesh being different than a property of the input mesh, at least another one of the training meshes being a mesh having dissimilar properties to the input mesh, wherein at least a plurality of the properties of the mesh being different than a plurality of properties of the input mesh;

extract properties from the input mesh and the plurality of training meshes;

compute values for the extracted properties, the computed values being inputs to a neural network to be trained;

input the computed values to the neural network to generate corresponding output values;

adjust the neural network to (i) converge the output values for the input mesh and the mesh having similar properties to the input mesh and (ii) diverge the output values for the input mesh and the mesh having dissimilar properties to the input mesh, to train the neural network; and

use the trained neural network to identify meshes similar to an unknown mesh input to the trained neural network.

The system described above, wherein the input mesh and the plurality of training meshes are normalized prior to extracting the properties.

The system described above, wherein the input mesh and the plurality of training meshes define three-dimensional objects.

The system described above, wherein the at least one memory and the computer program code are further configured to, with the at least one processor, cause the at least one processor to transform the input mesh to a perceptually similar mesh as the mesh having similar properties to the input mesh.

The system described above, wherein the at least one memory and the computer program code are further configured to, with the at least one processor, cause the at least one processor to generate the mesh having dissimilar properties to the input mesh by arbitrarily selecting a random mesh from a memory.

The system described above, wherein the at least one memory and the computer program code are further configured to, with the at least one processor, cause the at least one processor to generate the mesh having similar properties to the input mesh based on a user input or by automatically changing the at least one property feature.

The system described above, wherein the computed values correspond to values relating to at least one of volumetric information, shape information, or topology information.

A computerized method for training a neural network, the computerized method comprising:

generating a plurality of training meshes based on an input mesh, the plurality of training meshes including at least one mesh perceptually similar to the input mesh and one arbitrarily selected mesh perceptually dissimilar to the input mesh;

training the neural network using the input mesh and the plurality of training meshes by tuning output of the neural network to identify similar non-identical meshes; and

using the trained neural network to identify meshes similar to an unknown mesh input to the trained neural network.

The computerized method described above, further comprising adjusting the neural network to (i) converge output values from the neural network for the input mesh and a mesh having similar properties to the input mesh and (ii) diverge output values from the neural network for the input mesh and a mesh having dissimilar properties to the input mesh.

The computerized method described above, further comprising normalizing the input mesh and the plurality of training meshes to compute values for properties of the input mesh and the plurality of training meshes, and inputting the values to the neural network for training.

The computerized method described above, wherein the computed values correspond to values relating to at least one of volumetric information, shape information, or topology information.

The computerized method described above, wherein the input mesh and the plurality of training meshes define three-dimensional objects.

The computerized method described above, further comprising automatically generating the plurality of training meshes based on meshes stored in a memory.

The computerized method described above, further comprising training the neural network by adjusting nodes of the neural network to one of converge or diverge output values generated from the plurality of training meshes with output values generated from the input mesh.

One or more computer storage media having computer-executable instructions for training a neural network that, upon execution by a processor, cause the processor to at least:

generate a plurality of training meshes based on an input mesh, the plurality of training meshes including at least one mesh perceptually similar to the input mesh and one arbitrarily selected mesh perceptually dissimilar to the input mesh;

train the neural network using the input mesh and the plurality of training meshes by tuning the output of the neural network to identify similar meshes; and

use the trained neural network to identify meshes similar to an unknown mesh input to the trained neural network.

The one or more computer storage media described above having further computer-executable instructions that, upon execution by a processor, cause the processor to at least adjust the neural network to (i) converge output values from the neural network for the input mesh and a mesh having similar properties to the input mesh and (ii) diverge output values from the neural network for the input mesh and a mesh having dissimilar properties to the input mesh.

The one or more computer storage media described above having further computer-executable instructions that, upon execution by a processor, cause the processor to at least normalize the input mesh and the plurality of training meshes to compute values for properties of the input mesh and the plurality of training meshes, and inputting the values to the neural network for training.

The one or more computer storage media described above, wherein the computed values correspond to values relating to at least one of volumetric information, shape information, or topology information, and the input mesh and the plurality of training meshes define three-dimensional objects.

The one or more computer storage media described above having further computer-executable instructions that, upon execution by a processor, cause the processor to at least automatically generate the plurality of training meshes based on meshes stored in a memory.

The one or more computer storage media described above having further computer-executable instructions that, upon execution by a processor, cause the processor to at least train the neural network by adjusting nodes of the neural network to one of converge or diverge output values generated from the plurality of training meshes with output values generated from the input mesh.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for training a neural network. The illustrated one or more processors 1104 together with the computer program code stored in memory 1114 constitute exemplary processing means for using and/or training neural networks.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for training a neural network, the system comprising:
at least one processor; and
at least one memory comprising computer program code, the at least one memory and the computer program code configured to, with the at least one processor, cause the at least one processor to:
generate a plurality of training meshes based on an input mesh, at least one of the training meshes being a mesh having similar properties to the input mesh, wherein at least one property of the mesh being different than a property of the input mesh, at least another one of the training meshes being a mesh having dissimilar properties to the input mesh, wherein at least a plurality of the properties of the mesh being different than a plurality of properties of the input mesh;
extract properties from the input mesh and the plurality of training meshes;
compute values for the extracted properties, the computed values being inputs to a neural network to be trained;
input the computed values to the neural network to generate corresponding output values;
adjust the neural network to (i) converge the output values for the input mesh and the mesh having similar properties to the input mesh and (ii) diverge the output values for the input mesh and the mesh having dissimilar properties to the input mesh, to train the neural network; and
use the trained neural network to identify meshes similar to an unknown mesh input to the trained neural network.

2. The system of claim 1, wherein the input mesh and the plurality of training meshes are normalized prior to extracting the properties.

3. The system of claim 1, wherein the input mesh and the plurality of training meshes define three-dimensional objects.

4. The system of claim 1, wherein the at least one memory and the computer program code are further configured to, with the at least one processor, cause the at least one processor to transform the input mesh to a perceptually similar mesh as the mesh having similar properties to the input mesh.

5. The system of claim 1, wherein the at least one memory and the computer program code are further configured to, with the at least one processor, cause the at least one processor to generate the mesh having dissimilar properties to the input mesh by arbitrarily selecting a random mesh from a memory.

6. The system of claim 1, wherein the at least one memory and the computer program code are further configured to, with the at least one processor, cause the at least one processor to generate the mesh having similar properties to the input mesh based on a user input or by automatically changing the at least one property.

7. The system of claim 1, wherein the computed values correspond to values relating to at least one of volumetric information, shape information, or topology information.

8. A computerized method for training a neural network, the computerized method comprising:
generating a plurality of training meshes based on an input mesh, the plurality of training meshes including at least one mesh perceptually similar to the input mesh and one arbitrarily selected mesh perceptually dissimilar to the input mesh;
training the neural network using the input mesh and the plurality of training meshes by tuning output of the neural network to identify similar non-identical meshes; and
using the trained neural network to identify meshes similar to an unknown mesh input to the trained neural network.

9. The computerized method of claim 8, further comprising adjusting the neural network to (i) converge output values from the neural network for the input mesh and a mesh having similar properties to the input mesh and (ii) diverge output values from the neural network for the input mesh and a mesh having dissimilar properties to the input mesh.

10. The computerized method of claim 8, further comprising normalizing the input mesh and the plurality of training meshes to compute values for properties of the input mesh and the plurality of training meshes, and inputting the values to the neural network for training.

11. The computerized method of claim 10, wherein the computed values correspond to values relating to at least one of volumetric information, shape information, or topology information.

12. The computerized method of claim 8, wherein the input mesh and the plurality of training meshes define three-dimensional objects.

13. The computerized method of claim 8, further comprising automatically generating the plurality of training meshes based on meshes stored in a memory.

14. The computerized method of claim 8, further comprising training the neural network by adjusting nodes of the neural network to one of converge or diverge output values generated from the plurality of training meshes with output values generated from the input mesh.

15. One or more computer storage media having computer-executable instructions for training a neural network that, upon execution by a processor, cause the processor to at least:
generate a plurality of training meshes based on an input mesh, the plurality of training meshes including at least one mesh perceptually similar to the input mesh and one arbitrarily selected mesh perceptually dissimilar to the input mesh;
train the neural network using the input mesh and the plurality of training meshes by tuning the output of the neural network to identify similar meshes; and
use the trained neural network to identify meshes similar to an unknown mesh input to the trained neural network.

16. The one or more computer storage media of claim 15 having further computer-executable instructions that, upon execution by a processor, cause the processor to at least adjust the neural network to (i) converge output values from the neural network for the input mesh and a mesh having similar properties to the input mesh and (ii) diverge output values from the neural network for the input mesh and a mesh having dissimilar properties to the input mesh.

17. The one or more computer storage media of claim 15 having further computer-executable instructions that, upon execution by a processor, cause the processor to at least normalize the input mesh and the plurality of training meshes to compute values for properties of the input mesh and the plurality of training meshes, and inputting the values to the neural network for training.

18. The one or more computer storage media of claim 16, wherein the computed values correspond to values relating to at least one of volumetric information, shape information, or topology information, and the input mesh and the plurality of training meshes define three-dimensional objects.

19. The one or more computer storage media of claim 15 having further computer-executable instructions that, upon execution by a processor, cause the processor to at least automatically generate the plurality of training meshes based on meshes stored in a memory.

20. The one or more computer storage media of claim 15 having further computer-executable instructions that, upon execution by a processor, cause the processor to at least train the neural network by adjusting nodes of the neural network to one of converge or diverge output values generated from the plurality of training meshes with output values generated from the input mesh.
